(19) United States
(12) Patent Application Publication
(10) Pub. No.: US 2023/0380516 A1
(43) Pub. Date: Nov. 30, 2023

(54) Educational Garment Assembly

(71) Applicant: LaShaunessye Williams, Glenwood, IL (US)

(72) Inventor: LaShaunessye Williams, Glenwood, IL (US)

(21) Appl. No.: 17/827,743

(22) Filed: May 29, 2022

(51) Int. Cl. A41B 13/10; A41D 27/08; A63H 5/00; G09B 19/02; H02J 7/02

(52) U.S. Cl. CPC A41B 13/10; A41D 27/08; A63H 5/00; G09B 19/02; H02J 7/02

(57) ABSTRACT

An educational garment assembly includes a bib that is wearable on a teacher a plurality of first mating members is integrated into the bib. A pocket is attached to the bib thereby facilitating the pocket to store a personal electronic device and a charging unit is integrated into the bib to charge the personal electronic device. A rattle and a teddy bear is each attachable to a respective one of the first mating members such that the rattle and the teddy bear is available for the child. A variety of shape panels is each attachable to respective first mating members such that the respective shape panels are available for educating the child about shapes. A plurality of number panels is each attachable to respective first mating members such that the respective number panels are available for educating the child about number.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to garment devices and more particularly pertains to a new garment device for assisting a teacher with educating a child. The device includes a bib that is wearable on a teacher and a mirror that is attached to the bib. The device includes a translucent pocket for storing a personal electronic device and a charging unit integrated into the bib for charging the personal electronic device. The device includes a teddy bear and a rattle that can be attached to the bib. The device includes a plurality of number panels and a plurality of shape panels that can each be attached to the bib.

### (2) Description of Related Art Including Information Disclosed Under 37 CFR 1.97 and 1.98

The prior art relates to garment devices including an apron which has a plurality of detachable appliqués. The prior art discloses a bib that has a pair of bottle holders for holding baby bottles. The prior art discloses a baby bib that has a plurality of loops for suspending objects from the loops. The prior art discloses a band that can be wrapped around an object and a plurality of toys that are suspended from the band.

### BRIEF SUMMARY OF THE INVENTION

An embodiment of the disclosure meets the needs presented above by generally comprising a bib that is wearable on a teacher a plurality of first mating members is integrated into the bib. A pocket is attached to the bib thereby facilitating the pocket to store a personal electronic device and a charging unit is integrated into the bib to charge the personal electronic device. A rattle and a teddy bear is each attachable to a respective one of the first mating members such that the rattle and the teddy bear is available for the child. A variety of shape panels is each attachable to respective first mating members such that the respective shape panels are available for educating the child about shapes. A plurality of number panels is each attachable to respective first mating members such that the respective number panels are available for educating the child about number.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a educational garment assembly according to an embodiment of the disclosure.

FIG. 2 is a front exploded view of an embodiment of the disclosure.

FIG. 3 is a back view of an embodiment of the disclosure.

FIG. 4 is a perspective in-use view of an embodiment of the disclosure.

### DETAILED DESCRIPTION OF THE INVENTION

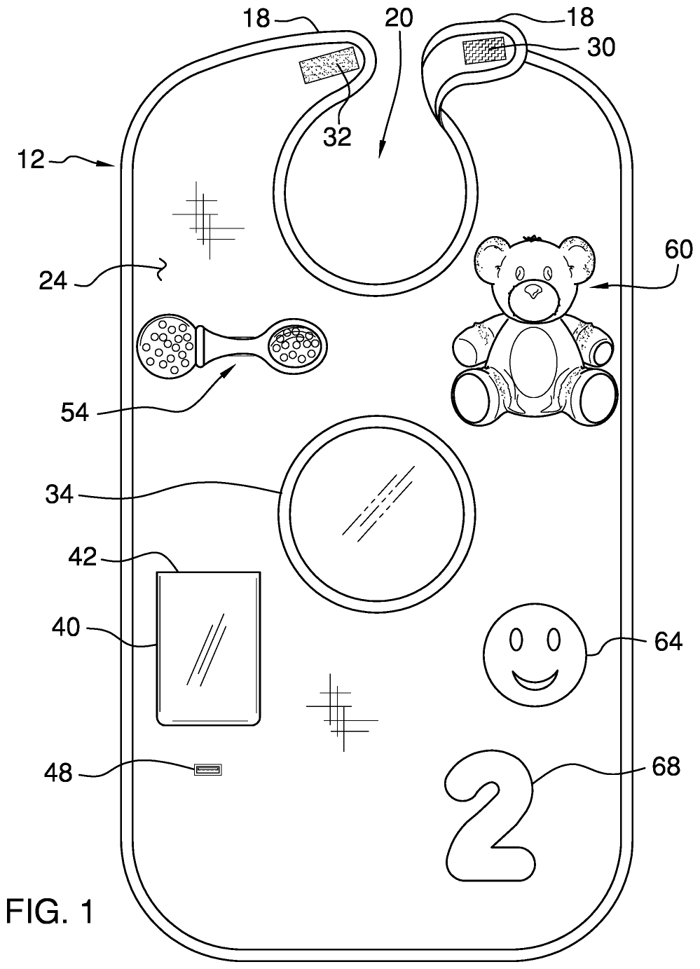

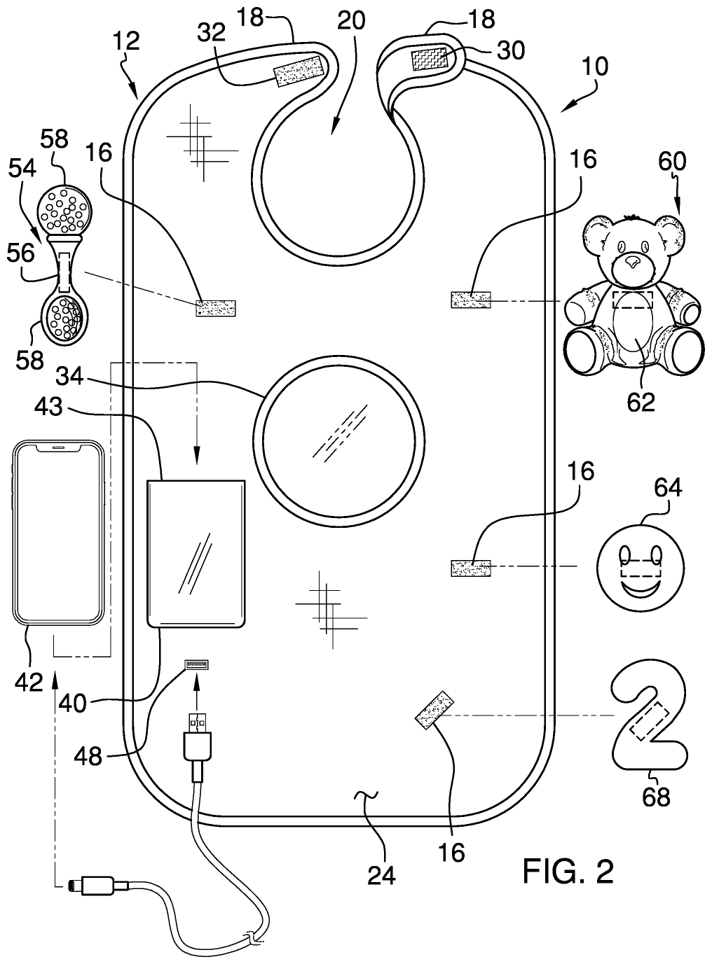

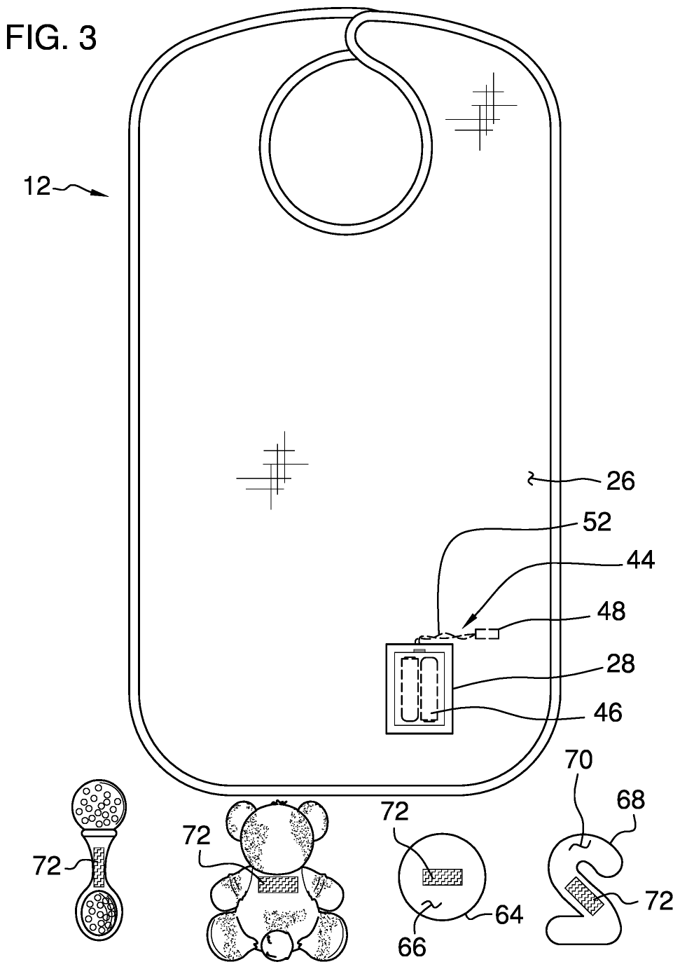

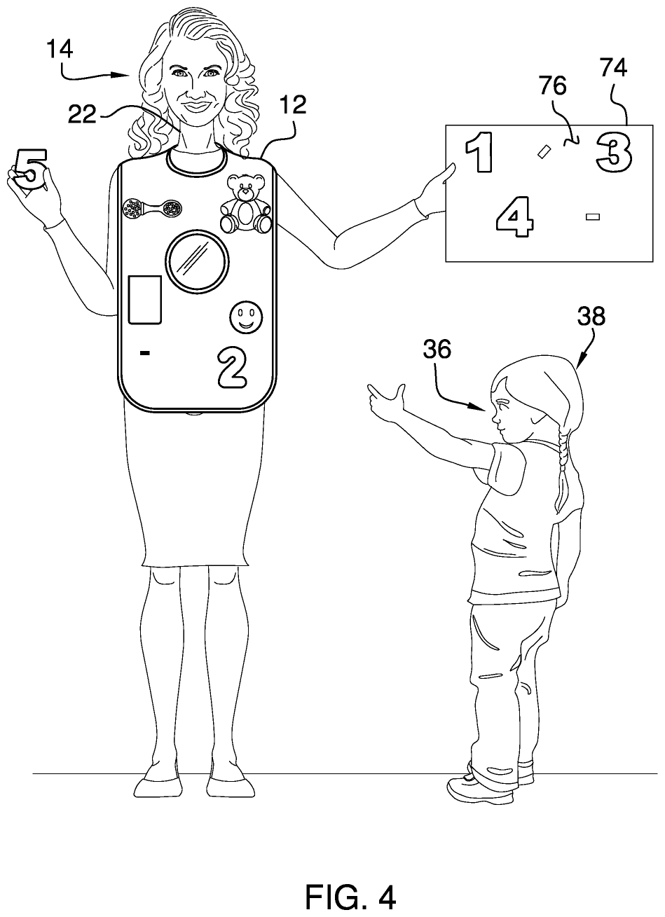

With reference now to the drawings, and in particular to FIGS. 1 through 4 thereof, a new garment device embodying the principles and concepts of an embodiment of the disclosure and generally designated by the reference numeral 10 will be described.

As best illustrated in FIGS. 1 through 4, the educational garment assembly 10 generally comprises a bib 12 that is wearable on a teacher 14 and a plurality of first mating members 16 is integrated into the bib 12. The bib 12 has a pair of arms 18 each curving toward each other such that the arms 18 defines a neck opening 20 for receiving the teacher's neck 22 having each of the arms 18 extending around the teacher's neck 22. The bib 12 has a front surface 24 and a back surface 26, and each of the first mating members 16 is positioned on the front surface 24. Additionally, the first mating members 16 are spaced apart from each other and are randomly distributed on the front surface 24.

Each of the arms 18 is matable to each other for retaining the arms 18 around the teacher's neck 22 and the bib 12 has a battery well 28 extending into the back surface 26. Each of the first mating members 16 may comprise a loop portion of a hook and loop fastener or other type of releasable fastener. A primary mating member 30 is coupled to the back surface 26 of the bib 12 and a secondary mating member 32 is attached to the front surface 24 of the bib 12. Each of the primary mating member 30 and the secondary mating member 32 are positioned on a respective one of the arms 18 for mating the arms 18 together.

A mirror 34 is attached to the bib 12 thereby facilitating the mirror 34 to reflect a child's face 36 to enhance self esteem of the child 38. The mirror 34 is positioned on the front surface 24 of the bib 12 and the mirror 34 is centrally positioned in the front surface 24. The mirror 34 may have a circular shape or other geometric shape. A pocket 40 is attached to the bib 12 thereby facilitating the pocket 40 to store a personal electronic device 42. The pocket 40 is positioned on the front surface 24 of the bib 12 and the pocket 40 has a top end 43 that is open. Furthermore, the pocket 40 is comprised of a translucent material thereby facilitating the personal electronic device 42 to be visible in the pocket 40. The personal electronic device 42 may be a smart phone or other type of electronic device that might be employed for educational purposes.

A charging unit 44 is integrated into the bib 12 thereby facilitating the personal electronic device 42 to be plugged into the charging unit 44 for charging the personal electronic device 42. The charging unit 44 comprises at least one battery 46 that is removably positioned in the battery well 28 in the back surface 26 of the bib 12. The charging unit 44 includes a charge port 48 that is recessed into the front surface 24 of the bib 12 thereby facilitating the charge port 48 to receive a charge cord 50 of the personal electronic device 42. The charging unit 44 includes a plurality of conductors 52 that is each electrically coupled between the charge port 48 and the at least one battery 46 for charging the personal electronic device 42.

A rattle 54 is provided and the rattle 54 is attachable to a respective one of the first mating members 16 such that the rattle 54 is available for the child 38. The rattle 54 has a handle 56 and the rattle 54 may have a pair of rattling elements 58 disposed on opposing ends of the handle 56. A teddy bear 60 is provided that is attachable to a respective one of the first mating members 16 such that the teddy bear 60 is available for the child 38 and the teddy bear 60 has a torso 62. A variety of shape panels 64 is provided and each of the shape panels 64 has a unique geometric shape with respect to each other. Respective ones of the shape panels 64 are attachable to respective first mating members 16 such that the respective shape panels 64 are available for educating the child 38 about shapes, and each of the shape panels 64 has a rear surface 66. A plurality of number panels 68 is provided and each of the number panels 68 is structured to resemble a respective number ranging between zero and nine. Respective ones of the number panels 68 is attachable to respective first mating members 16 such that the respective number panels 68 are available for educating the child 38 about number and each of the number panels 68 has a back surface 70.

A plurality of second mating members 72 is provided, a respective one of the second mating members 72 is attached to the handle 56 of the rattle 54 and a respective one of the second mating members 72 is attached to the torso 62 of the teddy bear 60. Respective ones of the second mating members 72 is attached to the rear surface 66 of the shape panels 64 and respective ones of the second mating members 72 is attached to the back surface 70 of the number panels 68. Furthermore, each of the second mating members 72 is releasably matable to a respective one of the first mating members 16. Each of the second mating members 72 may comprise a hook portion of a hook and loop fastener or other type of releasable fastener.

A board 74 is provided that has an engaging surface 76. The second mating member 72 on the number panels 68 and the shape panels 64 releasably engage the engaging surface 76. In this way the number panels 68 and the shape panels 64 can be displayed on the board 74 for the child 38. Thus, the teacher 14 can assist the child 38 with learning numbers and shapes in a variety of different ways.

In use, the bib 12 is worn on the teacher 14 and respective ones of the teddy bear 60, the rattle 54, the number panels 68 and the shape panels 64 can be attached to the bib 12. In this way the teddy bear 60, the rattle 54, the number panels 68 and the shape panels 64 that are worn on the bib 12 are accessible to the child 38. The personal electronic device 42 can be stored in the pocket 40 and the personal electronic device 42 can be plugged into the charging unit 44 for charging the personal electronic device 42. Additionally, selected number panels 68 and shape panels 64 can be displayed on the board 74, according to the wishes of the teacher 14 for educating the child 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An educational garment assembly for enhancing early childhood educational activities, said assembly comprising:
a bib being wearable on a teacher, said bib having a plurality of first mating members being integrated into said bib;
a mirror being attached to said bib thereby facilitating said mirror to reflect a child's face wherein said mirror is configured to enhance self esteem of the child;
a pocket being attached to said bib thereby facilitating said pocket to store a personal electronic device;
a charging unit being integrated into said bib thereby facilitating the personal electronic device to be plugged into said charging unit to charge the personal electronic device;
a rattle being attachable to a respective one of said first mating members such that said rattle is available for the child;
a teddy bear being attachable to a respective one of said first mating members such that said teddy bear is available for the child;
a variety of shape panels, each of said shape panels having a unique geometric shape with respect to each other, respective ones of said shape panels being attachable to respective first mating members such that said respective shape panels are available for educating the child about shapes; and
a plurality of number panels, each of said number panels being structured to resemble a respective number ranging between zero and nine, respective ones of said number panels being attachable to respective first mating members such that said respective number panels are available for educating the child about number.

2. The assembly according to claim 1, wherein:
said bib has a pair of arms each curves toward each other such that said arms defines a neck opening for receiving the teacher's neck having each of said arms extending around the teacher's neck, said bib having a front surface and a back surface, each of said first mating members being positioned on said front surface, said first mating members being spaced apart from each other and being randomly distributed on said front surface, each of said arms being matable to each other for retaining said arms around the teacher's neck, said bib having a battery well extending into said back surface;
said mirror is positioned on said front surface of said bib, said mirror being centrally positioned on said front surface; and
said pocket is positioned on said front surface of said bib, said pocket having a top end being open, said pocket being comprised of a translucent material thereby facilitating the personal electronic device to be visible in said pocket.

3. The assembly according to claim 2, wherein said charging unit comprises:
at least one battery being removably positioned in said battery well in said back surface of said bib;
a charge port being recessed into said front surface of said bib thereby facilitating said charge port to receive a charge cord of the personal electronic device; and
a plurality of conductors, each of said conductors being electrically coupled between said charge port and said at least one battery for charging the personal electronic device.

4. The assembly according to claim 1, wherein:
said rattle has a handle;
said teddy bear has a torso;
each of said shape panels has a rear surface;
each of said number panels has a back surface; and
said assembly includes a plurality of second mating members, a respective one of said second mating members being attached to said handle of said rattle, a respective one of said second mating members being attached to said torso of said teddy bear, respective ones of said second mating members being attached to said rear surface of said shape panels, respective ones of said second mating members being attached to said back surface of said number panels, each of said second mating members being releasably matable to a respective one of said first mating members.

5. The assembly according to claim 4, further comprising a board having an engaging surface, said second mating member on said number panels and said shape panels releasably engaging said engaging surface thereby facilitating said number panels and said shape panels to be displayed on said board for the child.

6. An educational garment assembly for enhancing early childhood educational activities, said assembly comprising:
a bib being wearable on a teacher, said bib having a plurality of first mating members being integrated into said bib, said bib having a pair of arms each curving toward each other such that said arms defines a neck opening for receiving the teacher's neck having each of said arms extending around the teacher's neck, said bib having a front surface and a back surface, each of said first mating members being positioned on said front surface, said first mating members being spaced apart from each other and being randomly distributed on said front surface, each of said arms being matable to each other for retaining said arms around the teacher's neck, said bib having a battery well extending into said back surface;
a mirror being attached to said bib thereby facilitating said mirror to reflect a child's face wherein said mirror is configured to enhance self esteem of the child, said mirror being positioned on said front surface of said bib, said mirror being centrally positioned in said front surface;
a pocket being attached to said bib thereby facilitating said pocket to store a personal electronic device, said pocket being positioned on said front surface of said bib, said pocket having a top end being open, said pocket being comprised of a translucent material thereby facilitating the personal electronic device to be visible in said pocket;
a charging unit being integrated into said bib thereby facilitating the personal electronic device to be plugged into said charging unit to charge the personal electronic device, said charging unit comprising:
at least one battery being removably positioned in said battery well in said back surface of said bib;
a charge port being recessed into said front surface of said bib thereby facilitating said charge port to receive a charge cord of the personal electronic device; and
a plurality of conductors, each of said conductors being electrically coupled between said charge port and said at least one battery for charging the personal electronic device;
a rattle being attachable to a respective one of said first mating members such that said rattle is available for the child, said rattle having a handle;
a teddy bear being attachable to a respective one of said first mating members such that said teddy bear is available for the child, said teddy bear having a torso;
a variety of shape panels, each of said shape panels having a unique geometric shape with respect to each other, respective ones of said shape panels being attachable to respective first mating members such that said respective shape panels are available for educating the child about shapes, each of said shape panels having a rear surface;
a plurality of number panels, each of said number panels being structured to resemble a respective number ranging between zero and nine, respective ones of said number panels being attachable to respective first mating members such that said respective number panels are available for educating the child about number, each of said number panels having a back surface;
a plurality of second mating members, a respective one of said second mating members being attached to said handle of said rattle, a respective one of said second mating members being attached to said torso of said teddy bear, respective ones of said second mating members being attached to said rear surface of said shape panels, respective ones of said second mating members being attached to said back surface of said number panels, each of said second mating members being releasably matable to a respective one of said first mating members; and
a board having an engaging surface, said second mating member on said number panels and said shape panels releasably engaging said engaging surface thereby facilitating said number panels and said shape panels to be displayed on said board for the child.
